(19) United States
(12) Patent Application Publication
(10) Pub. No.: US 2019/0118066 A1
(43) Pub. Date: Apr. 25, 2019

(54) METHOD AND APPARATUS FOR PROVIDING INTERACTIVE FITNESS EQUIPMENT VIA A CLOUD-BASED NETWORKING

(71) Applicant: iNmotion Wellness, Inc., San Jose, CA (US)

(72) Inventors: Don Lee Cardona, San Jose, CA (US); Jasmeer K. Abdulvahid, San Jose, CA (US); Jane Marie Dwyer, San Jose, CA (US); Hemanth Kalluri, San Jose, CA (US)

(21) Appl. No.: 16/166,021

(22) Filed: Oct. 19, 2018

Related U.S. Application Data
(60) Provisional application No. 62/574,999, filed on Oct. 20, 2017.

(51) Int. Cl. A63B 71/06; A63B 24/00; A63B 22/02; A63B 21/00; A63B 21/072; A63B 22/06; G09B 19/00

(52) U.S. Cl. CPC A63B 71/0622; H04L 67/10; A63B 24/0075; A63B 24/0062; A63B 22/025; A63B 21/4037; A63B 24/0006; A63B 21/0726; A63B 22/0605; G09B 19/003; G09B 19/0092; A63B 2225/15; A63B 2071/063; A63B 2220/806; A63B 2220/805; A63B 2220/62; A63B 2230/50; A63B 2225/50; A63B 2220/40; A63B 2024/0012; A63B 2024/0081; A63B 2024/0093; A63B 2071/0638; A63B 2071/0647; A63B 2071/0658; A63B 2071/0694; A63B 2220/56; A63B 2230/06; A63B 2230/75; A63B 24/0087

(57) ABSTRACT

A fitness training system discloses a process or method capable of providing interactive physical exercise using one or more smart fitness equipment (“SFE”). The process, in one aspect, is able to receive an authentication request from an SFE initiated by a user via an authenticator. After retrieving a profile representing a set of predefined information relating to the user from a user profile storage in accordance with the authentication request, an interactive fitness plan is generated based on the profile and a predefined set of datasets produced by one or more fitness machine learning modules using big data. Upon activating a set of sensors capable of monitoring the user in accordance with the interactive fitness plan, various movements associated with the user are detected and/or sensed by the sensors. The process is configured to provide interactive feedback to the user during the workout in response to detected movements.

### PRIORITY

This application claims the benefit of priority based upon U.S. Provisional Patent Application Ser. No. 62/574,999, filed on Oct. 20, 2017 in the name of the same inventor and entitled “Method and System for Providing Inmotion Smart Equipment Using Data Analytics, AI, IoT Fitness Project,” the disclosure of which is hereby incorporated into the present application by reference.

### FIELD

The exemplary embodiment(s) of the present invention relates to the field of physical wellness machines. More specifically, the exemplary embodiment(s) of the present invention relates to smart fitness equipment.

### BACKGROUND

Conventional exercise or cardio workout machines such as treadmills, ellipticals, stationary bikes are generally passive workout machines. Although some machines allow a user to enter limited static workout attributes or preferences, such as duration, inclination, resistance, heartrate, such preferences are typically passive. For example, common parameters are speed and inclination for treadmills, resistance levels for stationary bikes and so on.

A drawback associated with a conventional workout machine is that the parameters used and the variations over time during the workout session can be different. Another drawback is that the exercise machine does not remember the customization settings or preferences entered earlier. Another problem is that the workout history is not preserved. Also, a conventional exercise machine may contain a set of pre-configured programs that may not be appropriate for all users. Another problem associated with a conventional exercise machine is that its pre-configured programs do not consider other parameters outside exercise activity but relevant to users' overall fitness such as food habits, medical history, working environment, and the like.

### SUMMARY

A fitness training system discloses a process or method capable of providing interactive physical exercise using one or more smart fitness equipment (“SFE”). The process, in one aspect, is able to receive an authentication request from an SFE initiated by a user via an authenticator. After retrieving a profile representing a set of predefined information relating to the user from a user profile storage in accordance with the authentication request, an interactive fitness plan is generated based on the profile and a predefined set of datasets produced by one or more fitness machine learning modules using big data. Upon activating a set of sensors capable of monitoring the user in accordance with the interactive fitness plan, various movements associated with the user are detected and/or sensed by the sensors. The process is configured to provide interactive feedback to the user during the workout in response to detected movements.

Additional features and benefits of the exemplary embodiment(s) of the present invention will become apparent from the detailed description, figures and claims set forth below.

### BRIEF DESCRIPTION OF THE DRAWINGS

The exemplary embodiment(s) of the present invention will be understood more fully from the detailed description given below and from the accompanying drawings of various embodiments of the invention, which, however, should not be taken to limit the invention to the specific embodiments, but are for explanation and understanding only.

FIG. 1 is a block diagram illustrating a fitness training system (“FTS”) coupled to a cloud-based networking and capable of providing interactive feedback between user and smart fitness equipment (“SFE”) in accordance with one or more embodiments of the present invention;

FIG. 2 is a block diagram illustrating a smart fitness pod or studio capable of facilitating real-time feedback during a workout session in accordance with one or more embodiments of the present invention;

FIG. 3 is a block diagram illustrating an FTS having an interactive feedback capability in accordance with one or more embodiments of the present invention;

FIG. 4 is a block diagram illustrating an alternative FTS having an interactive feedback capability in accordance with one or more embodiments of the present invention;

FIG. 5 is a block diagram illustrating a cloud-based networking configured to facilitate interactive feedback between user and one or more SFEs in accordance with one or more embodiments of the present invention;

FIG. 6 is a block diagram illustrating an integrated fitness cloud configured to facilitate interactive feedback for physical workout in accordance with one or more embodiments of the present invention;

FIG. 7 is a flowchart illustrating a process of providing interactive feedback during a workout session using FTS in accordance with one embodiment of the present invention; and

FIG. 8 is a block diagram illustrating a digital processing system capable of being configured to be FTS, SFE, SML system, and/or SFP in accordance with one or more embodiments of the present invention.

### DETAILED DESCRIPTION

Embodiments of the present invention are described herein with context of a method and/or apparatus for facilitating real-time interactive feedback between user and FTS using SFE as well as a cloud-based networking.

The purpose of the following detailed description is to provide an understanding of one or more embodiments of the present invention. Those of ordinary skills in the art will realize that the following detailed description is illustrative only and is not intended to be in any way limiting. Other embodiments will readily suggest themselves to such skilled persons having the benefit of this disclosure and/or description.

In the interest of clarity, not all of the routine features of the implementations described herein are shown and described. It will, of course, be understood that in the development of any such actual implementation, numerous implementation-specific decisions may be made in order to achieve the developer's specific goals, such as compliance with application- and business-related constraints, and that these specific goals will vary from one implementation to another and from one developer to another. Moreover, it will be understood that such a development effort might be complex and time-consuming, but would nevertheless be a routine undertaking of engineering for those of ordinary skills in the art having the benefit of embodiment(s) of this disclosure.

Various embodiments of the present invention illustrated in the drawings may not be drawn to scale. Rather, the dimensions of the various features may be expanded or reduced for clarity. In addition, some of the drawings may be simplified for clarity. Thus, the drawings may not depict all of the components of a given apparatus (e.g., device) or method. The same reference indicators will be used throughout the drawings and the following detailed description to refer to the same or like parts.

In accordance with the embodiment(s) of present invention, the components, process steps, and/or data structures described herein may be implemented using various types of operating systems, computing platforms, computer programs, and/or general-purpose machines. In addition, those of ordinary skills in the art will recognize that devices of a less general-purpose nature, such as hardware devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

The term “system” or “device” is used generically herein to describe any number of components, elements, sub-systems, devices, packet switch elements, packet switches, access switches, routers, networks, computer and/or communication devices or mechanisms, or combinations of components thereof. The term “computer” includes a processor, memory, and buses capable of executing instruction wherein the computer refers to one or a cluster of computers, personal computers, workstations, mainframes, or combinations of computers thereof.

One embodiment of the present invention discloses a fitness training system (“FTS”) capable of providing interactive physical exercise using one or more smart fitness equipment (“SFE”). The process, in one aspect, is able to receive an authentication request from an SFE initiated by a user via an authenticator. After retrieving a profile representing a set of predefined information relating to the user from a user profile storage in accordance with the authentication request, an interactive fitness plan is generated based on the profile and a predefined set of datasets produced by one or more fitness machine learning (“FML”) modules using big data. Upon activating a set of sensors capable of monitoring the user in accordance with the interactive fitness plan, various movements associated with the user are detected and/or sensed by the sensors. The process is configured to provide interactive feedback to the user during the workout in response to detected movements.

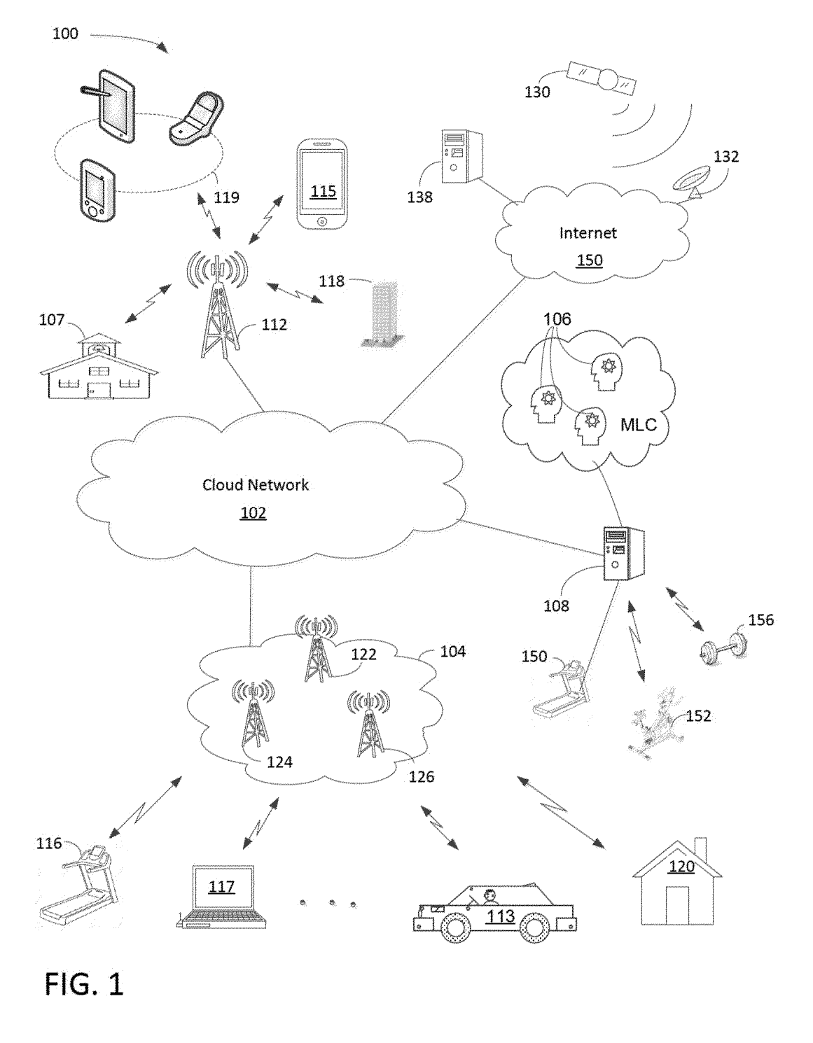

FIG. 1 is a block diagram 100 illustrating a fitness training system (“FTS”) coupled to a cloud-based networking and capable of providing interactive feedback between user and smart fitness equipment (“SFE”) in accordance with one or more embodiments of the present invention. Diagram 100 illustrates server or AI server 108, communication network 102, switching network 104, Internet 150, and portable electric devices 115-119. Network or cloud network 102 can be wide area network (“WAN”), metropolitan area network (“MAN”), local area network (“LAN”), satellite/terrestrial network, or a combination of WAN, MAN, and LAN. In one aspect, network 102 is configured to be a cloud-based networking for FTS. It should be noted that the underlying concept of the exemplary embodiment(s) of the present invention would not change if one or more blocks (or networks) were added to or removed from diagram 100.

Network 102 includes multiple network nodes, not shown in FIG. 1, wherein each node may include mobility management entity (“MME”), radio network controller (“RNC”), serving gateway (“S-GW”), packet data network gateway (“P-GW”), or Home Agent to provide various network functions. Network 102 is coupled to Internet 150, AI server 108, base station 112, and switching network 104. Server 108, in one embodiment, includes machine learning computers (“MLC”) 106 configured to aggregate, organize, collect, and process a large amount data gathered by various SFEs as well as FTS.

Switching network 104, which can be referred to as packet core network, includes cell sites 122-126 capable of providing radio access communication, such as 3G (3^{rd} generation), 4G, or 5G cellular networks. Switching network 104, in one example, includes IP and/or Multiprotocol Label Switching (“MPLS”) based network capable of operating at a layer of Open Systems Interconnection Basic Reference Model (“OSI model”) for information transfer between clients and network servers. In one embodiment, switching network 104 is logically coupling multiple devices, such as, not limited to, smart treadmill 116, portable computer 117, moving automobile 113, and house 120, across a geographic area via cellular and/or wireless networks. It should be noted that the geographic area may refer to a campus, city, metropolitan area, country, continent, or the like.

Base station 112, also known as cell site, node B, or eNodeB, includes a radio tower capable of coupling to various user equipments (“UEs”). For example, UEs can be cellular phone, laptop computer 117, iPhone® 115, tablets and/or iPad® 119 via wireless communications. Handheld device can also be a smartphone, such as iPhone®, BlackBerry®, Android®, and so on. Base station 112, in one example, facilitates network communication between mobile devices such as portable handheld device 115-119 via wired and wireless communications networks. In one embodiment, base station 112 also couple to a gym 107 and company 118 wherein gym 107 or company 118 may contain SFEs. It should be noted that base station 112 may include additional radio towers as well as other land switching circuitry.

Internet 150 is a computing network using Transmission Control Protocol/Internet Protocol (“TCP/IP”) to provide linkage between geographically separated devices for communication. Internet 150, in one example, couples to supplier server 138 and satellite network 130 via satellite receiver 132. Satellite network 130, in one example, can provide many functions as wireless communication as well as global positioning system (“GPS”).

In one aspect, IA server 108 is configured to host FTS which is logically connected to a smart treadmill 150, smart stationary bike 152, and smart dumbbell 156. FTS is able to provide real-time feedback to a user who is in a process of workout before an SFE or SFP. It should be noted that smart treadmill 150, stationary bike 152, and/or dumbbell 156 can be either specialized or normal exercise machines. Specialized machine can be a normal machine with an addition of special sensing capabilities. For example, a smart dumbbell can include one or more accelerometers configured to determine the direction and speed of dumbbell's movement. In one aspect, smart dumbbell can record the data indicating the speed and direction of dumbbell's movement, and subsequently transmits the data to FTS which can either be in the cloud, local system, or both.

It should be noted that an accelerometer measures direction based on a predefined coordinate(s). Alternatively, accelerometers can also detect vibration in a rotating motion. In one example, accelerometer with multi-axis may be used to detect magnitude and direction of the dumbbell.

An advantage of employing FTS is to facilitate real-time feedback to a user who is in a process of workout session. Depending on the application of the IA environment 106, FTS can be considered to perform a function of virtual physical trainer.

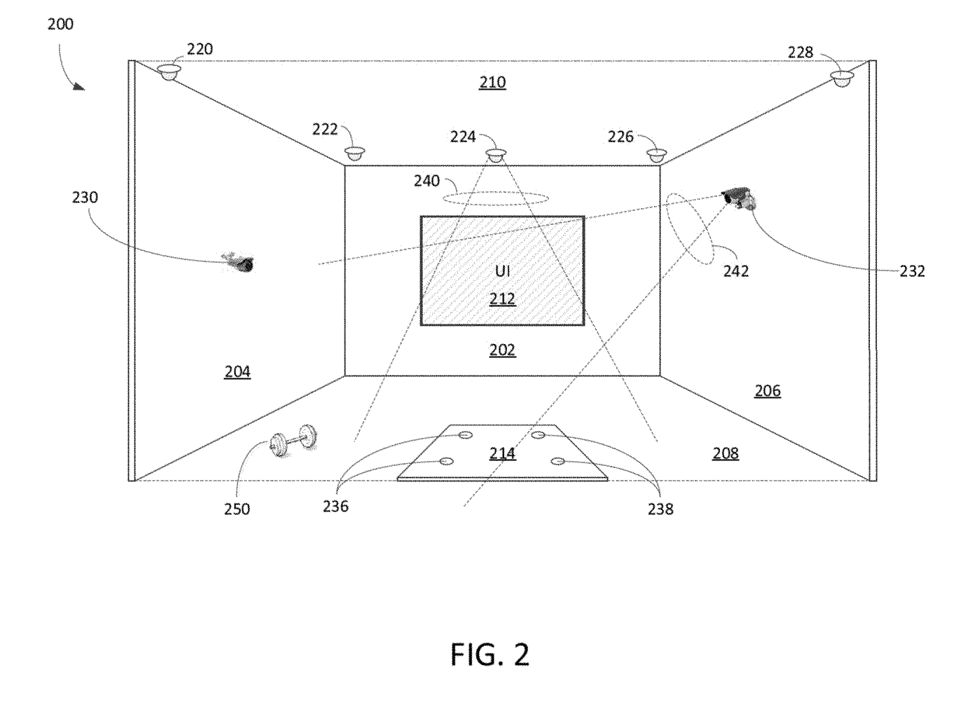

FIG. 2 is a block diagram 200 illustrating a smart fitness pod (“SFP”) or studio capable of facilitating real-time or instantaneous feedback during a workout session in accordance with one or more embodiments of the present invention. Diagram 200 includes a front wall 202, left wall 204, right wall 206, and floor pad or sensor mat 214. Alternatively, SFP also include a ceiling 210. In one embodiment, front wall 202 includes a user interface (“UI”) device 212 which could be monitor like apparatus that is capable of displaying images and broadcasting audio messages. It should be noted that the underlying concept of the exemplary embodiment(s) of the present invention would not change if one or more blocks (or devices) were added to or removed from diagram 200.

SFP, in one aspect, includes multiple video cameras 220-228, infrared cameras 230-232, and pressure sensors 236-238 mounted on floor pad 214. While video cameras 220-228 are mounted on walls and/or ceiling 210, infrared cameras or thermal cameras 230-232 can be installed or mounted on left wall 204 and right wall 206. Video cameras 220-228, in one embodiment, are strategically installed across ceiling 210 to achieve an optimal image capturing. Depending on the applications, cameras 220-232 can be mounted anywhere within the scope of SFP to capture intended images and/or data.

In one aspect, video camera such as camera 222 is used to authenticate a user using facial recognition software program. Upon identifying the identity (“ID”) of the user, the profile and information relating to the user are uploaded to SFP or SFE if SFE is placed within SFP. Infrared camera 230 or 232, in one example, is used to detect thermal temperature across user's body to determine which part or muscle is being worked out more than other parts or muscle of user's body. For example, when a portion of muscle emits higher temperature, the muscle (with higher temperature) is being trained and exercised.

Floor pad or sensor mat 214 includes various sensors 236-238 to monitor and detect user's presence, standing posture, exercise posture, and the like. In one example, floor pad 214 can be helpful to aggregate workout data for a user using the mat for free weight training, yoga, dancing, meditation, and the like. It should be noted that other types of sensors, such as motion, pressure, and/or audio sensors, can also be used to obtain data.

FTS, in one embodiment, is able to provide concurrent feedback as a virtual trainer to a user during an exercise session includes a smart exercise pad or sensor mat 214, one or more video cameras 220-228, SFE, and user interface (“UI”) 212. Smart exercise pad 214 which contains at least one sensor 236 or 238 detects a user's activity when the user stands on the smart exercise pad 214. Video camera or cameras 220-228 are configured to capture movement associated with the user for collecting exercise data relating to the user. SFE is capable of facilitating exercise activities to the user. The UI or UI 212, which can be a television, monitor, or a combination of television and monitor, is operable to provide real-time feedback to the user regarding to user's exercise sequence, posturing, speed, or duration in response to the collected exercise data. FTS further includes an infrared camera 230 configured to detect body temperature associated with the user. It should be noted that FTS is configured to provide network communication between the SFE and cloud.

In one embodiment, SFP or smart pod is a three (3) side-walled spacious workout booth. Each of these three walls 202-206 can house one or more sensors/high-resolution infra-red capable cameras 230-232 for generating, receiving, and/or aggregating data. The smart pod or SFP is designed for facilitating exercises and/or workouts that do not require ancillary workout equipment such as free weights. In one aspect, the sensors/high-resolution cameras such as cameras 220-232 monitor the body posture of a user in relaxed and extended positions required for a given exercise/workout. The captured data is then fed to a software algorithm that compares the input data with predefined reference (or correct) data for obtaining correct posture(s) and/or proposed positions and provides a real-time feed back to the user based on the result of comparison.

In operation, the user, for example, will be asked to attain both (CORRECT) relaxed and extended positions during the initialization of SFP. The sensors/high-resolution cameras 220-232 will record these positions which the software algorithm then compares with the reference (correct) values to provide the user with a real-time feedback. The images from the high-resolution cameras will be analyzed using advanced image processing algorithms which is then fed to the software algorithm that does the comparative analysis for the accuracy or correctness of the workout.

The smart pod or SFP, in one embodiment, uses a sensor mat, that is able to detect pressures at the (body-to-floor) touch points. For a given exercise, the allowed touch-points, for example, are used as reference. The pressure sensors continuously monitor the base pressure. If, for instance, the user deviates from the correct or allowed touch points, the software algorithm or FTS will provide an immediate real-time feedback alerting the user to adjust him/her body posture to comply with the correct workout procedure.

SFP or smart pod, in one embodiment, includes a set of smart free weights equipment such as smart dumbbell 250 wherein the smart pod is configured to provide a virtual trainer as a personal trainer facilitating a session of free weight training and/or exercise. To measure dumbbell motion and speed, one approach is to use one or more tri-axis accelerometer that can detect and measure minute to large anterior-posterior and side-to-side movements of the dumbbell that it is attached to. For example, the accelerometer can be semiconductor or CMOS based device that is able to detect motion in three axes in response to voltage changes from the base.

For example, each dumbbell or smart dumbbell 250 includes one or more accelerometers embedded in it. When the user, for instance, picks up the dumbbell and stabilizes his/her posture to the base position, the base (start) values are captured as reference and the change in voltages during the exercise/workout are measured against the base values. A special software algorithm will then match the “new” voltages to the reference (the correct values for that user) voltage for accuracy of the workout and provide the user a real-time feedback.

Depending on the exercise/workout, one or all three axes' voltages on one or both dumbbells are captured and analyzed in real-time. Accompanying the (smart) dumbbell will be a pressure sensor mat such as mat 214 with (foot) reference positions for a given exercise/workout. The user then positions his/her feet on the reference markers that the mat will capture the base (start) values. Each of these reference markers on the pressure sensor mat will incorporate at least two separate sensors to measure heel and toe pressures. Depending on what the correct posture (of the feet) is for a given exercise/workout, the sensor(s) continuously measure the pressure values (voltages) and an algorithm will then compare with the reference (correct) values to give the user a real-time visual/text feedback.

Depending on the exercise/workout, the dumbbell is placed (touching) the pressure sensor mat which embeds additional sensor to obtain reference or correct position(s). Accompanying the sensor mat and dumbbell includes at least one high-resolution infra-red capable camera to detect user's body posture using advanced image processing algorithms. The detected body posture is then again compared to the reference (or correct) posture and a real-time feedback is provided to the user for the duration of the exercise/workout session. Additionally, the infra-red cameras can pinpoint individual muscle based on the elevated temperature of that particular muscle, and the software algorithm can provide immediate real-time visual feedback to the user.

In one aspect, FTS or SFP is capable of distinguishing foot placement for both the POD (functional body weight movements which encompasses isometric & plyometric) or Dumbbell/Free Weights lifts which will relay foot-placement. For example, if the foot is pronating incorrectly, it could affect form and cause injury to prospective user or client. With the capability of instantaneous feedback, such potential injury and/or relay importance of proper foot pressure and placement can be reduced.

Closed kinetic chain exercises, for example, are physical movements performed where the hand or foot is fixed in space and cannot move (as stationary). The extremity remains in constant contact with the immobile surface/censored mat. In an alternative embodiment, sensor mat is replaced with a leg press or squat machine to achieve similar sensing capability as the censored mat. It should be noted that the real-time detection of the user's body, feet and the dumbbell in relaxed and extended positions improve the effectiveness of the workout as well as prevent or reduce injuries which could be a result of incorrect workout postures. In addition, the aggregated data can be analyzed by a fitness professional to further guide/improve the user's workout regimen.

A benefit of using FTS is that it creates a self-sustaining ecosystem which enables people to retrieve real time data that prevents or reduces injury and drives sustainable workout results. The advantage of using FTS with various algorithm and SFP is to improve postural deviations within each individual user or client because FTS can observe and/or define correct versus incorrect biomechanics. Another advantage of using FTS is to reduce work deficiencies based on each individual user or client during Kinetic Chain movements.

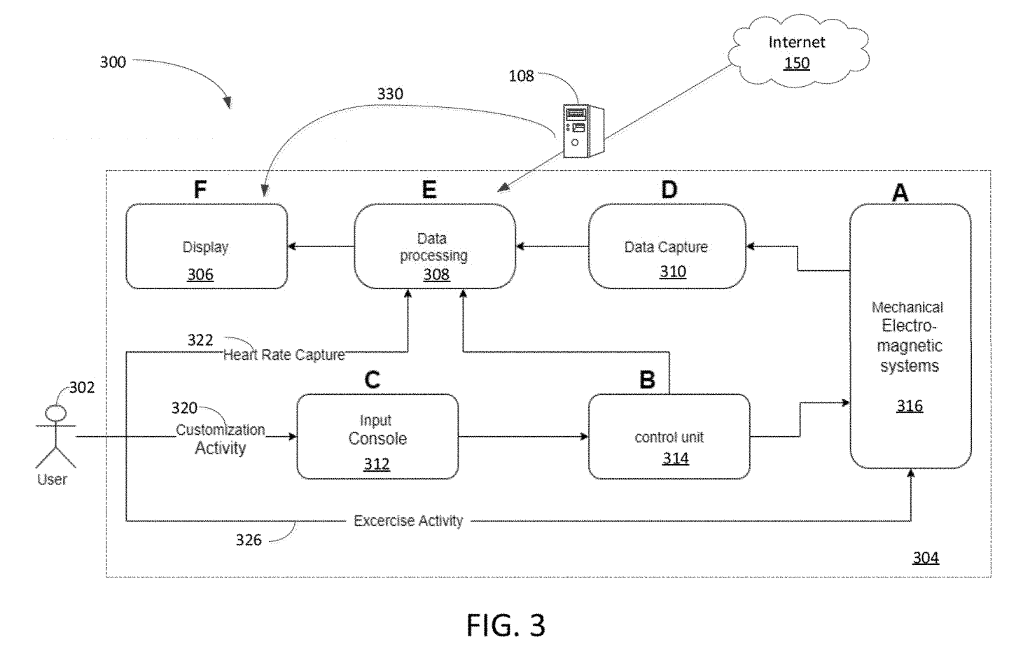

FIG. 3 is a block diagram 300 illustrating an FTS having an interactive feedback capability using an SFE in accordance with one or more embodiments of the present invention. Diagram 300 includes a user 302, SFE 304, FTS server 108, and internet 150. FTS server 108, in one aspect, is configured to facilitate communication between a cloud-based fitness networking and user 302 via SFE 304. User 302 can be a client, person, patient, athletes, and the like. It should be noted that the underlying concept of the exemplary embodiment(s) of the present invention would not change if one or more blocks (or devices) were added to or removed from diagram 300.

FSE 304 can be a cardio workout equipment or strength training machine capable of providing instantaneous feedback. To simply forgoing discussion, a cardio workout equipment is used. A cardio workout equipment is a cardio exercise machine, such as treadmill, stationary bike, elliptical, and the like, capable of enhancing cardio exercise during a workout session. FSE 304, in one aspect, includes a display 306, data processing unit 308, data capture 310, input console 312, control unit 314, and mechanical electro-magnetic (“MEM”) system 316. It should be noted that components 306-316 are applicable to many types of fitness equipment. In reality some components may not be present in certain types of equipment whereas in other cases same physical component may provide multiple logical functions.

MEM system 316 includes electrical-mechanical subsystem, such as motors, magnetic resistance, flywheels, et cetera, for facilitating physical exercise. Control unit 314, in one embodiment, is an electronic system that controls electrical-mechanical subsystem by changing customization parameters such as resistance levels, motor speeds, inclination level, et cetera. In one aspect, control unit 314 receives input from user 302 via input console 312 and generates output to data processing unit 308 and MEM system 316.

Input console 312, in one aspect, is an interface device in which user 302 interacts with FSE 304 for customizing one or more parameters. For example, input console 312 includes mechanical levers, electronic push buttons, computerized touch screens, and the like for accepting user's input. Data capture 310 is configured to monitor mechanical subsystems and records changes its physical parameters such as speed and duration. The recorded data is subsequently fed to data processing unit 308 for analysis and report.

Data processing unit 308, in one example, is a central processing unit (“CPU”) which is the brain of the system capable of processing inputs and displaying its results in display 306 or display console. In one aspect, processing unit 308 receives user customized parameters via control unit 314, heart rate/other vital data from user 302 as indicated by numeral 322, and/or speed/other parameters from MEM system 316. In one aspect, data processing unit 308 is configured to communicate with FTS server 108 to facilitate real-time or instantaneous feedback to enhance effectiveness workout as well as reducing unintended injuries from the workout during an exercise session. Data processing unit 308, in addition to display information, as such calories burned, duration, and/or heart rate, unit 308 can also perform a function of virtual trainer.

An advantage of using FTS is to remember customization or settings for each registered user or user previously used the machine. For example, SFE 304 is able to automatically reset the machine to the last user setting when the same user comes back.

Another advantage of using FTS is to preserve data or settings. For example, SFE 304 stores detected workout data such as speed, resistance level, duration, hear beat rate, and calories burned. Note that recorded workout data can be valuable for tracking progress, modifying exercise programs, and big data analysis.

Another advantage of using FTS is to provide a mechanism to learn and adapt the programs based on actual workout itself that is tailored to the user. For instance, FTS provides mechanisms for users to access and interact with their workout history or overall progress via big data and machine learning analysis.

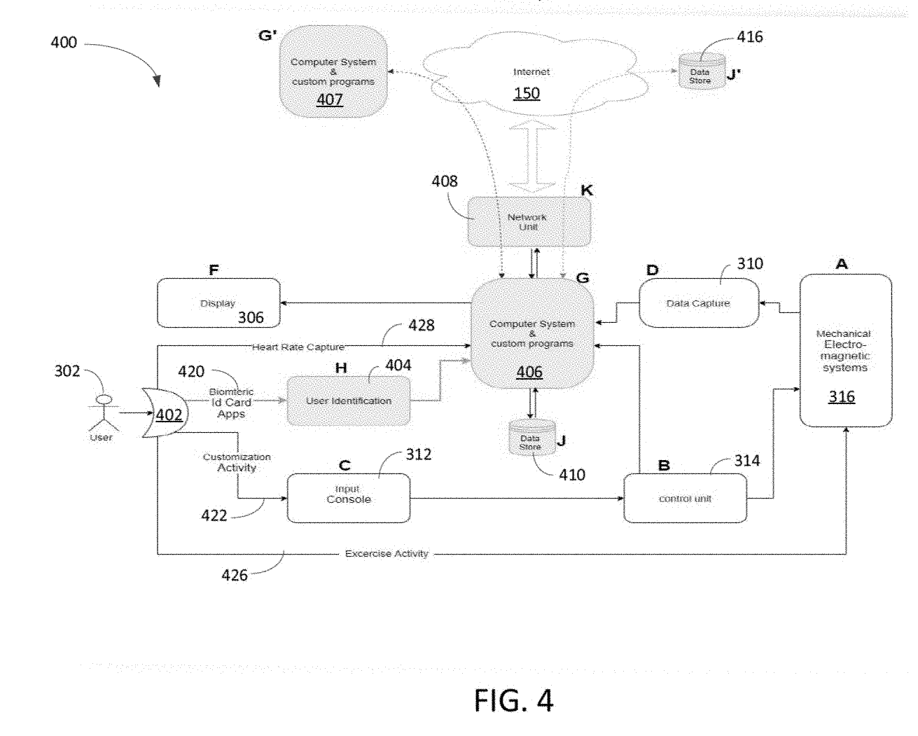

FIG. 4 is a block diagram 400 illustrating an alternative FTS having an interactive feedback capability in accordance with one or more embodiments of the present invention. Diagram 400 is similar to diagram 300 except that diagram 400 includes an interface device 402, user identification 404, computer systems 406-407, network unit 408, and internet 150. Computer systems 406-407 are coupled to data storage 410 and 416. It should be noted that the underlying concept of the exemplary embodiment(s) of the present invention would not change if one or more blocks (or devices) were added to or removed from diagram 400.

The FTS, in one embodiment, includes a smart cardio fitness (“SCF”) machine includes a general-purpose computer system or computer system 406 configured to execute custom programs for facilitating instantaneous feedback during an exercise session. A distinguishing feature of SCF machine is that it can identify the user and automatically customization parameters to those used by the same user previously. The identification feature occurs regardless of whether the user returns to the same SFF or not. User will be identified as long as the user uses any SCF managed by FTS connected to the cloud-based networking.

It should be noted that SCF machine illustrated in FIG. 4 shows a structure to separate data necessary for real-time feedback from aggregated data as well as data processing for big data analytics from the aggregated data. The data analytics can make use of other relevant parameters such as medical records, food intake and work-related activities which opens new possibilities for enhancing user experience and formulating innovative ways to deliver fitness services such as virtual trainer.

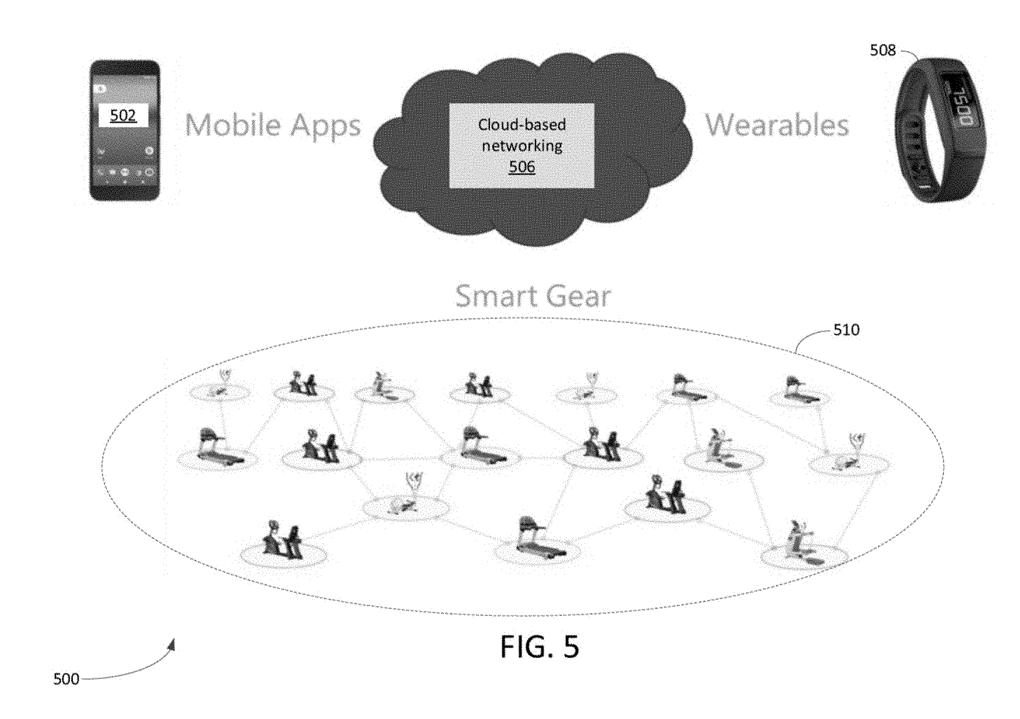

FIG. 5 is a block diagram 500 illustrating a cloud-based networking configured to facilitate interactive feedback between user and one or more SFEs in accordance with one or more embodiments of the present invention. Diagram 500 includes a mobile device 502, cloud-based networking 506, wearable device 508, and SCF machines or SFEs 510 wherein cloud-based networking is used to facilitate FTS. SFC machines 510 includes smart treadmills, stationary bikes, SFPs, and the like. It should be noted that the underlying concept of the exemplary embodiment(s) of the present invention would not change if one or more blocks (or devices) were added to or removed from diagram 500.

FTS, in one embodiment, provides a function of virtual trainer using multiple SFEs 510. SFEs 510 includes SFC machines and SFP wherein exemplary SFC machines includes smart or connected treadmill, strength training machines, and the like. SFP or studio is used for free weights form or functional exercise (i.e., those exercise activities w/o any fitness gear), such as, Dumbbell, pushup, pull-up bars, and the like. In one embodiment, SFEs 510 managed by FTS is capable of identifying user, recording user activities, generating predefined exercise program, providing instantaneous feedback, aggregating data, analyzing aggregated data.

SFE, in one aspect, is capable of identifying the user who is intended to use the SFE. For example, SFE can use its video camera to capture user's facial features to identify user's ID. Alternatively, SFE can request the user to enter his or her biometric ID such as fingerprint. In yet another embodiment, SFE can ask the user to login with input or remote login keys.

SFE, in one example, records user activity via capturing exercise data and saves the captured data in a non-volatile storage (“NVS”). NVS can be local inside the equipment or external in a cloud that could be accessed via network. The data collected includes equipment parameters such as speed, acceleration, inclination, height, weight, trajectory, physical parameters associated with the equipment, and the like. The aggregated data also includes users' vital signs such as users' heartrate and muscle activity. Also, user's posture is also being captured by equipment such as using cameras to capture the posture of the user while exercising. SFE also employs infrared cameras to capture user's thermal image identifying the body parts/muscle that is activated and/or exercised.

SFE managed by FTS is configured to support pre-defined exercise programs. User can select a program as a guide to workout. These programs may be built-in or could be downloaded from an external source. For example, the program can be downloaded from the Internet or a server, via computer network.

SFE, in one aspect, also provide a feedback and correcting mechanism. For example, SFE analyzes user's activity and prompts correctional changes in response to local processing capabilities as well as the cloud-based fitness networking as would be done by a physical trainer. In one aspect, SFE managed by FTS is configured as a built-in virtual trainer.

The data collected, in one embodiment, can be categorized into several categories. The first category or first type of data collected is directed to the corrections which includes activities that is used to compare against sensed data with the requirements of the pre-defined program user who is engaged to ensure that user is following the program as per the requirements. For example, the data can show whether user posture is correct or not. The second category or type of data collected is used to analyze against user's history of workout data to improve efficiency. For example, if the user cannot keep up with the speed, prompt notification of slowdown is broadcasted to the user. The third category or type of data collected is to modify workout programs as the system learns from the history of all users in the cloud using machine learning capabilities to conduct part of analytics.

In one embodiment, some of the analysis require changes immediately in the way the user is in the process of workout in a real-time. Such changes will be communicated to the user via audio visual clues—using monitor screens. The human figures, for example, will be used to show how the posture is deviating from the correct or recommended human shadow(s). One implementation may have a human sketch figure or 3d model tracking the actual movement of the user and show arrows and colors and sound to guide the user back to the ‘correct’ movement or posture.

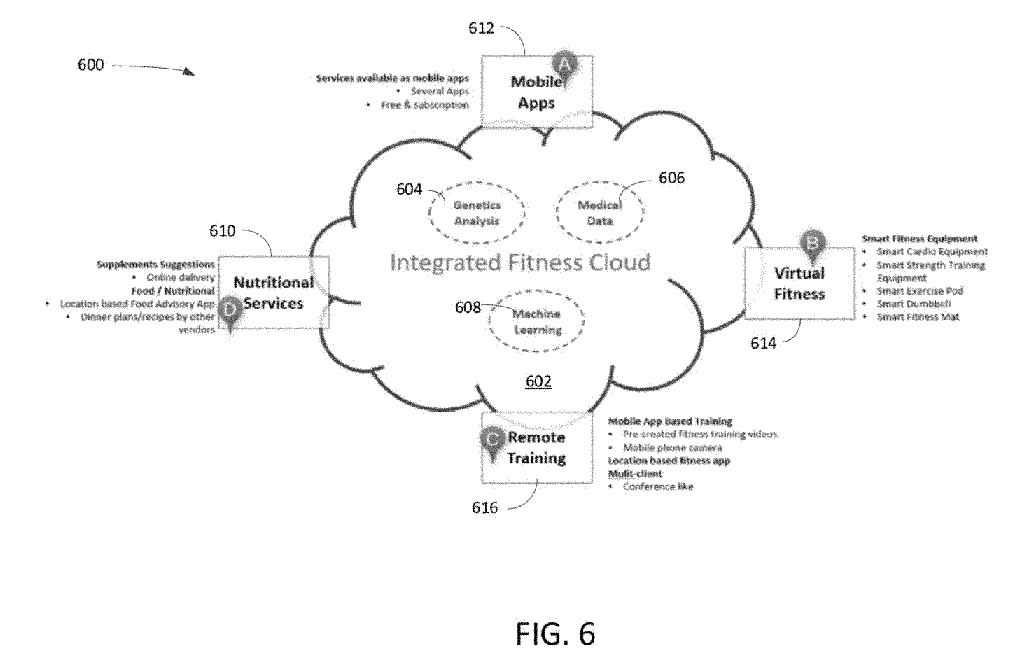

FIG. 6 is a block diagram 600 illustrating an integrated fitness cloud configured to facilitate interactive feedback for physical workout in accordance with one or more embodiments of the present invention. Diagram 600 includes an integrated fitness cloud (“IFC”) 602, mobile application (“Apps”) 612, nutritional services 610, virtual fitness 614, and remote training 616. In one aspect, IFC 602 includes a genetic analysis module 604, machine learning 608, and medical data 606, wherein machine learning 608 is used to analyze big data. It should be noted that the underlying concept of the exemplary embodiment(s) of the present invention would not change if one or more blocks (or devices) were added to or removed from diagram 600.

Mobile Apps 612, in one aspect, is used to broadcast services availability as mobile apps which can be downloaded as free subscription. Note that set of mobile apps to access the services can be many variations. Remote training 616 includes mobile app-based training, location-based fitness app, and multi-client wherein multi-client includes conference like scenario. The mobile app-based training may contain pre-created fitness training videos and mobile phone camera. In one embodiment, remote training 616 facilitates virtual training w/o specialized machines. For example, fitness programs can be delivered over mobile phones and mobile phone will be used, via camera feed, to monitor and guide the exercise by a remote trainer. The remote trainer can be one-on-one (1-1) or 1-Many conference type training sessions.

Nutritional services 610 includes supplements suggestions and food/nutritional application wherein supplements suggestions can contain online delivery. Food/nutritional application includes location-based food advisory application and dinner plans/recipes by other vendors. Nutritional services 610 provides a service offering supplements/food intake guidance, and delivers such supplements/food via mobile apps in response to the analysis which determines the type of supplements/foods the user may need.

Virtual fitness 614 includes SFEs including smart cardio equipment, smart strength training equipment, smart exercise pod, smart dumbbell, and smart fitness mat. Virtual fitness 614 manages various virtual fitness machines that can be used or leased by home, gym, hospitals, workplaces.

The exemplary embodiment of the present invention includes various processing steps, which will be described below. The steps of the embodiment may be embodied in machine or computer executable instructions. The instructions can be used to cause a general purpose or special purpose system, which is programmed with the instructions, to perform the steps of the exemplary embodiment of the present invention. Alternatively, the steps of the exemplary embodiment of the present invention may be performed by specific hardware components that contain hard-wired logic for performing the steps, or by any combination of programmed computer components and custom hardware components.

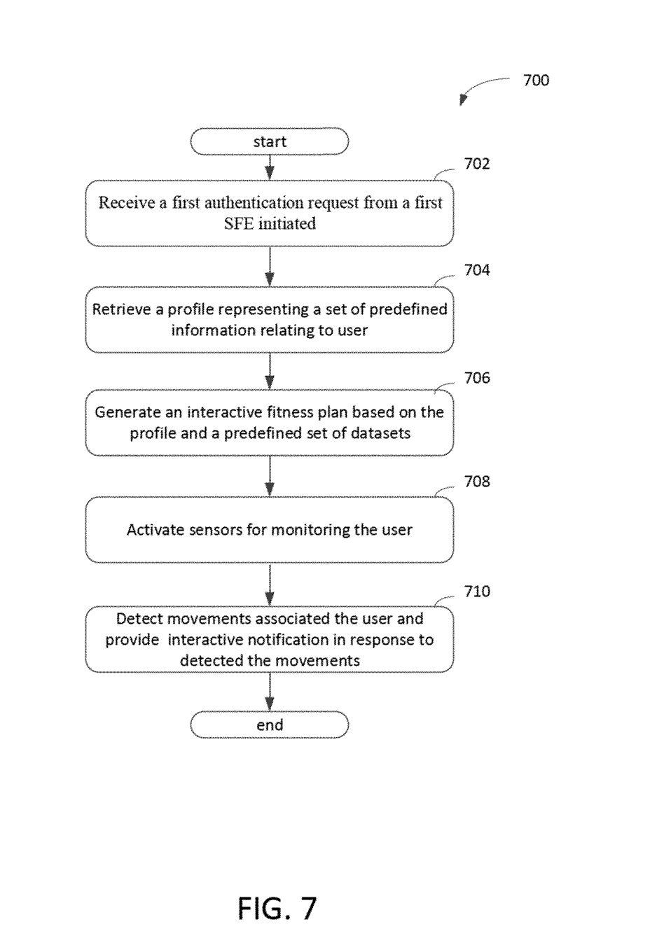

FIG. 7 is a flowchart 700 illustrating a process of providing interactive feedback during a workout session using FTS in accordance with one embodiment of the present invention. At block 702, the process of interactive physical exercise via FTS using one or more SFEs is able to receive a first authentication request from a first SFE initiated by a first user via a first authenticator. In one example, a fingerprint read is obtained from a biometric reader installed on a smart treadmill.

At block 704, a first profile representing a set of predefined information relating to the first user is retrieved from a user profile storage in accordance with the first authentication request. For example, a table containing first user's ID registration, workout habit, exercise history, and workout statistics is obtained from a local storage. Alternatively, a table containing first user's ID, registration, workout history, and workout statistics is obtained from a remote storage via a cloud-based networking.

At block 706, the process is capable of generating a first interactive fitness plan based on the first profile and a predefined set of datasets produced by one or more FML modules using big data. For example, an exercise sequence tailored to current condition of the first user is formulated in response to aggregated data having similar parameters as the first user.

At block 708, multiple sensors are activated for monitoring the first user in accordance with the first interactive fitness plan. For example, video camera is switched on for obtaining posturing information from the first user. In addition, the infrared camera may be turned on for obtaining thermal information associated with the first user.

At block 710, the first movements associated the first user are sensed by multiple sensors. The first interactive feedback is provided by the FTS to the first user in response to detected first movements. The exercising activities relating to the first user and location of exercise can also be captured. In one embodiment, a first user exercise image can be projected onto a first video screen showing current first user's exercise posture in accordance with the first movements. Also, a standard exercise image is also projected onto the first video screen showing a suggested exercise posture to the first user in accordance with the predefined set of datasets. In one aspect, a superimposed image combining the standard exercise image and the first user exercise image is display on the video screen to show the necessary posture corrections. A voice message is broadcasted to the first user suggesting a change of exercise posture based on the first user exercise image and the standard exercise image. In one aspect, the process is able to provide an automatic adjustment to the first SFE in response to the first user exercise image and the standard exercise image. The time sensitive data is identified from collected data and forwarding the time sensitive data to the FTS with minimal delay. For example, data relating to instantaneous feedback is time sensitive data. The aggregated data is identified from collected data and forwarding the aggregated data to the FTS at a low-traffic time. After receiving a second authentication request from a second SFE initiated by a second user via a second authenticator, a second profile representing a set of predefined information relating to the second user is retrieved from a user profile storage in accordance with the second authentication request. Upon generating a second interactive fitness plan based on the second profile and a predefined set of datasets produced by one or more FML modules using big data, multiple sensors are activated for monitoring the second user in accordance with the second interactive fitness plan. The process is able to detect second movements associated the second user sensed by the sensors and provide second interactive notification to the second user in response to detected second movements.

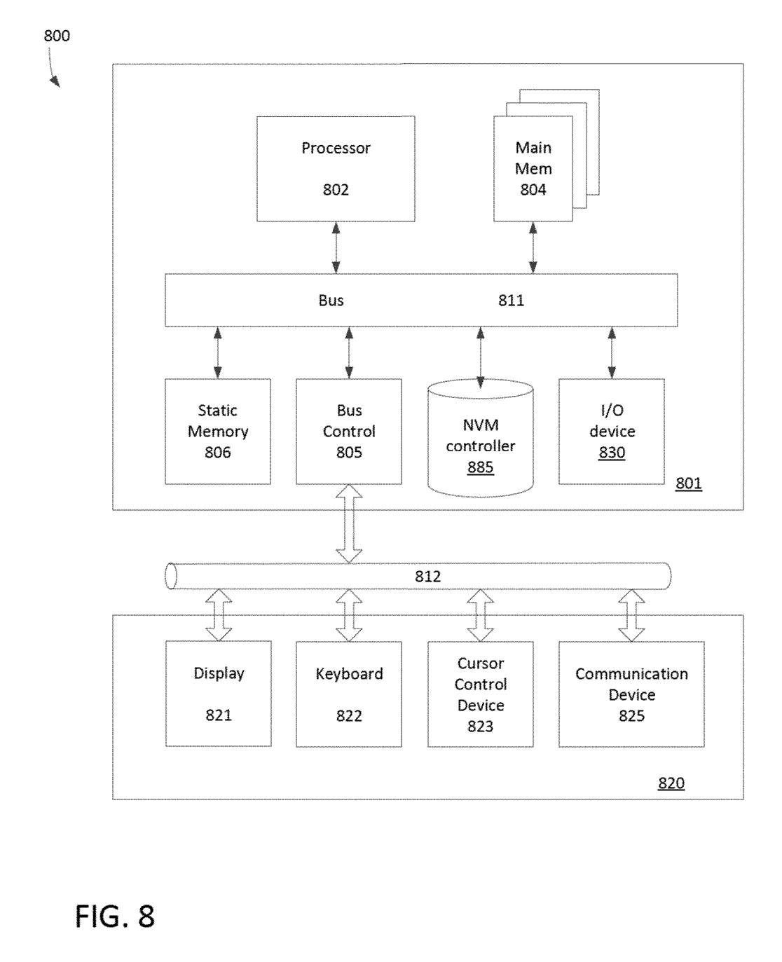

FIG. 8 is a block diagram 800 illustrating a digital processing system capable of being configured to be FTS, SFE, SML system, and/or SFP in accordance with one or more embodiments of the present invention. Computer system 800 can include a processing unit 801, an interface bus 812, and an input/output (“TO”) unit 820. Processing unit 801 includes a processor 802, main memory 804, system bus 811, static memory device 806, bus control unit 805, I/O element 830, and NVM controller 885. It should be noted that the underlying concept of the exemplary embodiment(s) of the present invention would not change if one or more blocks (circuit or elements) were added to or removed from FIG. 8.

Bus 811 is used to transmit information between various components and processor 802 for data processing. Processor 802 may be any of a wide variety of general-purpose processors, embedded processors, or microprocessors such as ARM® embedded processors, Intel® Core™ Duo, Core™ Quad, Xeon®, Pentium™ microprocessor, Motorola™ 68040, AMD® family processors, or Power PC™ microprocessor.

Main memory 804, which may include multiple levels of cache memories, stores frequently used data and instructions. Main memory 804 may be RAM (random access memory), MRAM (magnetic RAM), or flash memory. Static memory 806 may be a ROM (read-only memory), which is coupled to bus 811, for storing static information and/or instructions. Bus control unit 805 is coupled to buses 811-812 and controls which component, such as main memory 804 or processor 802, can use the bus. Bus control unit 805 manages the communications between bus 811 and bus 812. Mass storage memory or SSD which may be a magnetic disk, an optical disk, hard disk drive, floppy disk, CD-ROM, and/or flash memories are used for storing large amounts of data.

I/O unit 820, in one embodiment, includes a display 821, keyboard 822, cursor control device 823, and communication device 825. Display device 821 may be a liquid crystal device, cathode ray tube (“CRT”), touch-screen display, or other suitable display device. Display 821 projects or displays images of a graphical planning board. Keyboard 822 may be a conventional alphanumeric input device for communicating information between computer system 800 and computer operator(s). Another type of user input device is cursor control device 823, such as a conventional mouse, touch mouse, trackball, or other type of cursor for communicating information between system 800 and user(s).

Communication device 825 is coupled to bus 811 for accessing information from remote computers or servers, such as server or other computers, through wide-area network. Communication device 825 may include a modem or a network interface device, or other similar devices that facilitate communication between computer 800 and the network. Computer system 800 may be coupled to a number of servers via a network infrastructure such as the infrastructure illustrated in FIG. 1.

While particular embodiments of the present invention have been shown and described, it will be obvious to those of ordinary skills in the art that based upon the teachings herein, changes and modifications may be made without departing from this exemplary embodiment(s) of the present invention and its broader aspects. Therefore, the appended claims are intended to encompass within their scope all such changes and modifications as are within the true spirit and scope of this exemplary embodiment(s) of the present invention.

What is claimed is:

1. A method of interactive physical exercise via a fitness training system (“FTS”) using one or more smart fitness equipment (“SFE”), comprising:
receiving a first authentication request from a first SFE initiated by a first user via a first authenticator;
retrieving a first profile representing a set of predefined information relating to the first user from a user profile storage in accordance with the first authentication request;
generating a first interactive fitness plan based on the first profile and a predefined set of datasets produced by one or more fitness machine learning (“FML”) modules using big data;
activating a plurality of sensors for monitoring the first user in accordance with the first interactive fitness plan; and
detecting first movements associated the first user sensed by the plurality of sensors and provide first interactive feedback to the first user in response to detected first movements.

2. The method of claim 1, further comprising projecting a first user exercise image onto a first video screen showing current first user's exercise posture in accordance with the first movements.

3. The method of claim 2, further comprising projecting a standard exercise image onto the first video screen showing a suggested exercise posture to the first user in accordance with the predefined set of datasets.

4. The method of claim 3, further comprising broadcasting a voice message to the first user suggesting a change of exercise posture based on the first user exercise image and the standard exercise image.

5. The method of claim 3, further comprising automatic adjustment to the first SFE in response to the first user exercise image and the standard exercise image.

6. The method of claim 1, wherein receiving the first authentication request includes obtaining a fingerprint read from a biometric reader installed on a smart treadmill.

7. The method of claim 1, wherein retrieving a first profile includes obtaining a table containing first user's identity (“ID”), registration, workout habit, exercise history, and workout statistics from a local storage.

8. The method of claim 1, wherein retrieving a first profile includes obtaining a table containing first user's identity (“ID”), registration, workout history, and workout statistics from a remote storage via a cloud-based networking.

9. The method of claim 1, wherein generating a first interactive fitness plan includes formulating an exercise sequence tailored to current condition of the first user in response to aggregated data having similar parameters as the first user.

10. The method of claim 1, wherein activating a plurality of sensors for monitoring the first user includes switching on video camera for obtaining posturing information from the first user.

11. The method of claim 1, wherein activating a plurality of sensors for monitoring the first user includes switching on infrared camera for obtaining thermal information associated with the first user.

12. The method of claim 1, wherein detecting first movements associated the first user includes capturing exercising activities relating to the first user and location of exercise.

13. The method of claim 1, further comprising identifying time sensitive data from collected data and forwarding the time sensitive data to the FTS with minimal delay.

14. The method of claim 1, further comprising identifying aggregated data from collected data and forwarding the aggregated data to the FTS at a low-traffic time.

15. The method of claim 1, further comprising:
receiving a second authentication request from a second SFE initiated by a second user via a second authenticator;
retrieving a second profile representing a set of predefined information relating to the second user from a user profile storage in accordance with the second authentication request;
generating a second interactive fitness plan based on the second profile and a predefined set of datasets produced by one or more fitness machine learning (“FML”) modules using big data;
activating a plurality of sensors for monitoring the second user in accordance with the second interactive fitness plan; and
detecting second movements associated the second user sensed by the plurality of sensors and provide second interactive notification to the second user in response to detected second movements.

16. An apparatus configured to provide concurrent feedback to a user during an exercise session comprising:
a smart exercise pad, containing at least one sensor, configured to detect a user's activity when the user stands on the smart exercise pad;
at least one video camera coupled to the smart exercise pad and configured to capture movement associated with the user for collecting exercise data relating to the user;
a smart fitness equipment (“SFE”) coupled to the smart exercise pad and configured to facilitate exercise activities to the user; and
a user interface (“UI”) device coupled to the SFE and operable to provide real-time feedback to the user regarding one of exercise sequence, posturing, speed, and duration in response to the collected exercise data.

17. The system of claim 16, further includes an infrared camera coupled to the smart exercise pad and configured to detect body temperature associated with the user.

18. The system of claim 16, further includes a fitness training system (“FTS”) coupled to the UI and configured to provide network communication between the SFE and cloud.

19. A method of interactive physical exercise via a fitness training system (“FTS”) system using one or more smart fitness equipment (“SFE”), comprising:
activating at least one video camera to capture a video image when a user is detected by a motion sensor in a smart fitness pod (“SFP”);
retrieving a profile representing a set of predefined information relating to the user from a user profile storage when user's facial recognition satisfies with an authentication process;
generating an interactive fitness plan based on the profile and a predefined set of datasets produced by one or more fitness machine learning (“FML”) modules using big data;
activating a plurality of sensors for monitoring the user in accordance with the interactive fitness plan; and
detecting movements associated with the user sensed by the plurality of sensors and provide interactive notification to the user in response to detected movements.

20. The method of claim 19, further comprising:
displaying a user exercise image onto a video screen showing current user's exercise posture in accordance with the movements; and
displaying a standard exercise image onto the video screen showing a suggested exercise posture to the user in accordance with the predefined set of datasets.
